(19) United States
(12) Patent Application Publication
(10) Pub. No.: US 2007/0242354 A1
(43) Pub. Date: Oct. 18, 2007

(54) Optical head device with film wavelength plate incorporated therein

(75) Inventors: Takashi Takahashi, Tokyo (JP); Nobuki Tanaka, Tokyo (JP); Takaaki Saito, Tokyo (JP); Tatsuya Nakata, Tokyo (JP)

Correspondence Address: FOLEY AND LARDNER LLP;SUITE 500, 3000 K STREET NW, WASHINGTON, DC, 20007, US

(73) Assignee: KABUSHIKI KAISHA TOPCON

(21) Appl. No.: 11/714,913

(22) Filed: Mar. 7, 2007

(30) Foreign Application Priority Data
Mar. 24, 2006 (JP) 2006-081895

(51) Int. Cl. G02B 27/28

(52) U.S. Cl. 359/495

(57) ABSTRACT

Members such as a laser diode (10) that is a light source, a diffraction grating (11), a polarizing beam splitter (12) and a collimator lens are arranged in a casing (20). An optical head device having such a casing (20) is improved, so that a film wavelength plate (14) is directly attached to the casing (20) in a form free from a support substrate. The film wavelength plate (14) consists of only one film and has a thickness of 0.2 to 1.0 mm. Particularly, the film wavelength plate is preferably constituted by fusing polycarbonate films in a three-layer structure.

### TECHNICAL FIELD

The present invention relates to an optical head device with film wavelength plate incorporated therein and, particularly, an optical head device with film wavelength plate incorporated therein, which is used for recording and reproducing information by irradiating an optical disk such as a CD (component disc), a DVD (digital versatile disc,™), a Blu-ray Disc™, or other optical storage media with semiconductor laser beam.

### RELATED ART

As conventional wavelength plates are known a retardation film composed of a polyolefin resin (e.g., refer to Claims of Japanese Patent Unexamined Publication (JP-A) No. 60-24502), a laminated wavelength plate obtained by mutually laminating a wavelength plate giving a phase difference of ½ wavelength and a wavelength plate giving a phase difference of ¼ wavelength through an adhesive (e.g., refer to Japanese Patent Unexamined Publication (JP-A) Nos. 5-100114 and 10-68816), a phase difference film composed of one polymer orientation film, the polymer orientation film satisfying a predetermined condition (e.g., refer to Claims, Paragraphs [0035] and [0115] of Japanese Patent Registration (JP-B) No. 3325560), a wavelength plate which attained λ/4 or λ/2 with a wide wavelength band and a wide view angle, using one polymer film (e.g., refer to Claims, and Paragraph [0004] of Japanese Patent Unexamined Publication (JP-A) No. 2001-208913).

Conventionally known wavelength plates further include a ¼ wavelength plate including a film layer formed on a surface (one side) of a bed substrate and a polydiacetylene derivative film formed on the surface by vacuum evaporation (e.g., refer to Paragraphs [0038] to [0041] of Japanese Patent Unexamined Publication (JP-A) No. 10-300928), a ¼ wavelength plate including a cyclic polyolefin-based resin film laminated on a glass substrate 0.3 mm in thickness through an adhesive (e.g., refer to Paragraph of Japanese Patent Unexamined Publication (JP-A) No. 2001-124925), a wavelength plate including different phase difference films A-1 and A-2 laminated on both sides of a glass plate using an adhesive so that the respective optical axes are 60° (e.g., refer to Paragraph [0089] of Japanese Patent Unexamined Publication (JP-A) No. 2003-344652), and a ¼ wavelength plate including a polymer resin film with uniform thickness, e.g., a film wavelength plate formed of norbornene resin boded to one side of a flat plate formed of an anisotropic crystal material (anisotropic crystal plate), e.g., a quartz wavelength plate (e.g., refer to Paragraph [0007] of Japanese Patent Unexamined Publication (JP-A) No. 2002-166321).

The single wavelength plate or laminated wavelength plate as disclosed in JP-A Nos. 60-24502, 5-100114 and 10-68816, JP-B No. 3325560 and JP-A No. 2001-208913 is necessarily fixed onto and supported by a transparent support substrate such as a glass plate when mounted on a device such as an optical head or projector. Since the support substrate is necessarily used, the number of manufacturing processes is increased, resulting in deterioration of working efficiency.

The wavelength plate deposited on a bed substrate or the wavelength plate fixed to one side or both sides of the glass plate through an adhesive, as disclosed in JP-A Nos. 10-300928, 2001-124925, 2003-344652 and 2002-116321, can be deteriorated or peeled from the bed substrate or a support substrate such as the glass plate by change of the environmental temperature within the device such as the optical head or projector because it is fixed by deposition or through the adhesive.

Further, the wavelength plate fixed to a glass plate through adhesive often cannot show satisfactory aberration characteristic because the wave aberration of the laser beam transmitted by the wavelength plate is changed.

### SUMMARY OF THE INVENTION

An object of the present invention is to provide an optical head device, which can improve work efficiency by dispensing with a support substrate such as a glass plate.

According to one mode of the present invention, an optical head device has a casing in which a light source, a diffraction grating, a polarizing beam splitter and a collimator lens are arranged. The optical head device includes a film wavelength plate incorporated therein by being directly attached to the casing in a form free from a support substrate.

In the above-mentioned optical head device, the film wavelength plate consists of one film and has a thickness of 0.2 to 1.0 mm.

In the above-mentioned optical head device, the film wavelength plate is constituted by fusing polycarbonate films in a structure of three layers or more.

In the above-mentioned optical head device, only the periphery of the film wavelength plate is adhered to the optical head device.

According to another mode of the present invention, an optical head device has a casing in which a light source, a diffraction grating, a polarizing beam splitter, and a collimator lens are arranged. The optical head device includes a film wavelength plate incorporated therein by being directly attached to a prism in a form free from a support substrate.

In the above-mentioned optical head device, the diffraction grating is formed on the film wavelength plate.

According to the present invention, a film wavelength plate can be mounted on an optical head device while perfectly dispensing with adhesion of the film wavelength plate to a support substrate such as a glass plate.

Members such as a light source (e.g., a laser diode), a diffraction grating, a polarizing beam splitter, and a collimator lens are arranged in the casing of the optical head device. The film wavelength plate is directly attached to such a casing in a form free from a support substrate.

The film wavelength plate preferably consists of one film, and has a thickness of 0.2 to 1.0 mm.

Particularly, the film wavelength plate is preferably constituted by fusing polycarbonate films in a structure of three layers or more. In the present invention, the film wavelength plate is not limited thereby, and may be formed of a plastic plate or an organic thin film such as cycloolefin-based polymer, polycarbonate, or polyvinyl alcohol (PVA), for example.

A structure of five layers or more, preferably of six layers or more is preferable for the application to Blu-ray.

In the above-mentioned structure of three layers or more, a ¼λ film wavelength plate, a ½λ film wavelength plate or an (n+1)/4λ film wavelength plate (n is a natural number) can be manufactured according to the layer structure to be cut. In the manufacturing process thereof, a material enhancing rigidity, for example, a hard coat is preferably provided. For example, a thermosetting resin, a photo-hardenable resin or the like is provided on the surface. Preferable examples thereof include hard coat layers using melamine resin, silicon resin, urethane resin, acrylic resin and the like. A hard coat using silicon-based resin is particularly preferred. For example, the hard coat is preferably provided by deposition.

When only the periphery of the film wavelength plate is adhered to the optical head device, the change of wave aberration of the laser beam transmitted by the wavelength plate can be avoided. Therefore, according to the present invention, satisfactory aberration characteristic can be ensured even if the adhesive is used.

Since optical characteristics (wave aberration, etc.) are changed depending on the direction of turning polarized light by the film wavelength plate or the environment for mounting the film wavelength plate on the optical head device, the wavelength plate is preferably manufactured while designing right turn or left turn so as to stabilize the optical characteristics. The film design can be freely performed.

### BRIEF DESCRIPTION OF THE DRAWINGS

FIG. 1 is a schematic illustrative view of an optical head device according to the present invention;

FIG. 2 is an illustrative view showing the state where a film wavelength plate is directly attached to the casing of the optical head device according to the present invention;

FIG. 3 is a graph comparatively showing the wave aberration characteristics of a conventional adhesion-type wavelength plate and a film wavelength plate of the present invention;

FIG. 4 is an illustrative view showing a modified example of the present invention; and

FIG. 5 is an illustrative view showing another modified example of the present invention.

### EMBODIMENTS

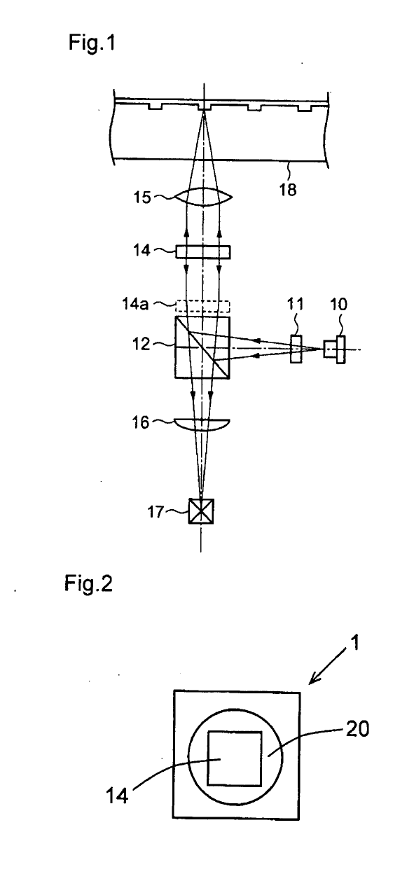

FIG. 1 shows one example of an optical head device according to the present invention.

The optical head device 1 comprises a laser diode 10 for semiconductor laser (light source), a diffraction grating 11, a polarizing beam splitter 12, a collimator lens (not shown), a film wavelength plate 14, an objective lens 15, a cylindrical lens 16, a light detector 17 and others.

The film wavelength plate 14 is directly adhered to a predetermined portion of the optical head device.

The arrangement position of the film wavelength plate 14 is changeable along the optical axis between the position shown by the full line and the position shown by the broken line (14a) within the optical head device 1.

Laser beam emitted from the laser diode 10 is diffracted by the diffraction grating 11, reflected by the polarizing beam splitter 12, and directed to a CD 18 (or DVD, Blu-ray disc).

The light reflected by the polarizing beam splitter 12 is regulated in phase to a predetermined wavelength (λ/4 or λ/2) by the film wavelength plate 14, and radiated to the CD 18 (or DVD, Blu-ray Disc, etc.) through the objective lens 15. The light reflected thereby is detected by the light detector 17.

Reproduction or storage of information of the CD 18 (or DVD, Blu-ray Disc, etc.) that is an information storage medium is performed in this form.

The light emitted from the laser diode 10 may be blue laser. In this case, the CD 18 performs recording and reproduction to an HD-DVD™ or Blu-ray Disc.

Two or more laser diodes 10, light detectors 17, diffracting gratings 11, polarizing beam splitters 12 and other elements can be set.

The wavelengths used in the optical head device shown in FIG. 1 are preferably λ₁=405±20 nm, λ₂=655±20 nm, and λ₃=785±20 nm.

FIG. 2 schematically shows the state of the film wavelength plate 14 directly attached to a casing of the optical head device (without a support substrate).

After removing an optical member such as the objective lens 15 within the optical head device, the film wavelength plate 14 is directly attached to the casing 20 having members such as the laser diode 10, the diffraction grating 11, the polarizing beam splitter 12 and the collimator lens arranged therein.

For example, the film wavelength plate 14 is directly adhered and fixed to the casing 20. At that time, an adhering margin of several mm is provided on the whole periphery of the film wavelength plate 14, and the adhesive is applied to the part of the adhering margin to fix the film wavelength plate 14 to the casing 20.

Otherwise, the film wavelength plate 14 can be also attached to the device casing 20 by fusing, without using the adhesive, by heating the adhering margin of the film wavelength plate 14 to some degree.

Since it is thus only the film wavelength plate alone that the optical head device is irradiated with laser beam, satisfactory wave aberration can be obtained as described below. Since no adhesive is used, light resistance (particularly, light resistance to Blu-ray) is satisfactory.

The film wavelength plate 14 preferably has a thickness of not less than 0.2 mm to not more than 1.0 mm, but can be thinned to a thickness of about not more than 0.2 mm to not less than 0.04 mm. The film wavelength plate is applicable also to a slim type (not more than 1.0 mm), a super-slim type (not less than 0.04 mm to not more than 0.2 mm), and an ultra-slim type (not more than 0.04 mm) in which further thinning is desired. The thickness of the film wavelength plate 14 can be set to not more than 0.01 mm, for example, about 0.005 mm.

An AR coat may be formed on one side or both sides of the film wavelength plate 14. The AR coat means a reflection preventive film to the light used.

Further, according to the film wavelength plate 14 of the present invention, a satisfactory relation between phase difference (Re value or retardation value) and temperature change can be easily maintained. With respect to the change of Re values at 650 nm, 780 nm, and 405 nm, for example, the retardation values are unchanged even at a high temperature of not lower than 80° C. Even if the environmental temperature within the optical head device is raised, for example, to 150° C. or higher, the film wavelength plate 14 is never affected by the temperature change by laser beam or the environmental temperature.

Even if the film wavelength plate 14 is moved between the position shown by the full line (14) and the position shown by the broken line (14b) in FIG. 1, or the film wavelength plate 14 is moved to an optional position between a position close to the laser light source (laser diode 10) and a position distant therefrom within the optical head device, the film wavelength plate 14 is never affected by the temperature change by laser beam. Therefore, the freedom in design related to the arrangement of the film wavelength plate 14 within the optical head device 1 is increased. Consequently, the film wavelength plate 14 can be set in various kinds of optical head devices 1, and the conformability can be thus increased.

The result of comparison for wave aberration between an “adhesion-type” ¼ wavelength plate which is stuck to one side of a glass substrate by applying an adhesive thereto and a “film-type” film wavelength plate (¼ film wavelength plate) used in the present invention is shown in Table 1.

TABLE 1

| | Adhesion type | Film type |
|---|---|---|
| Average value | 0.016 | 0.011 |
| Central value | 0.015 | 0.010 |
| | | (λrms) |

Further, in the “film-type” film wavelength plate used in the present invention, the wave aberration can be made smaller than 0.010 λrms, and the wave aberration characteristic of the film wavelength plate is more satisfactory in both the average value and the central value.

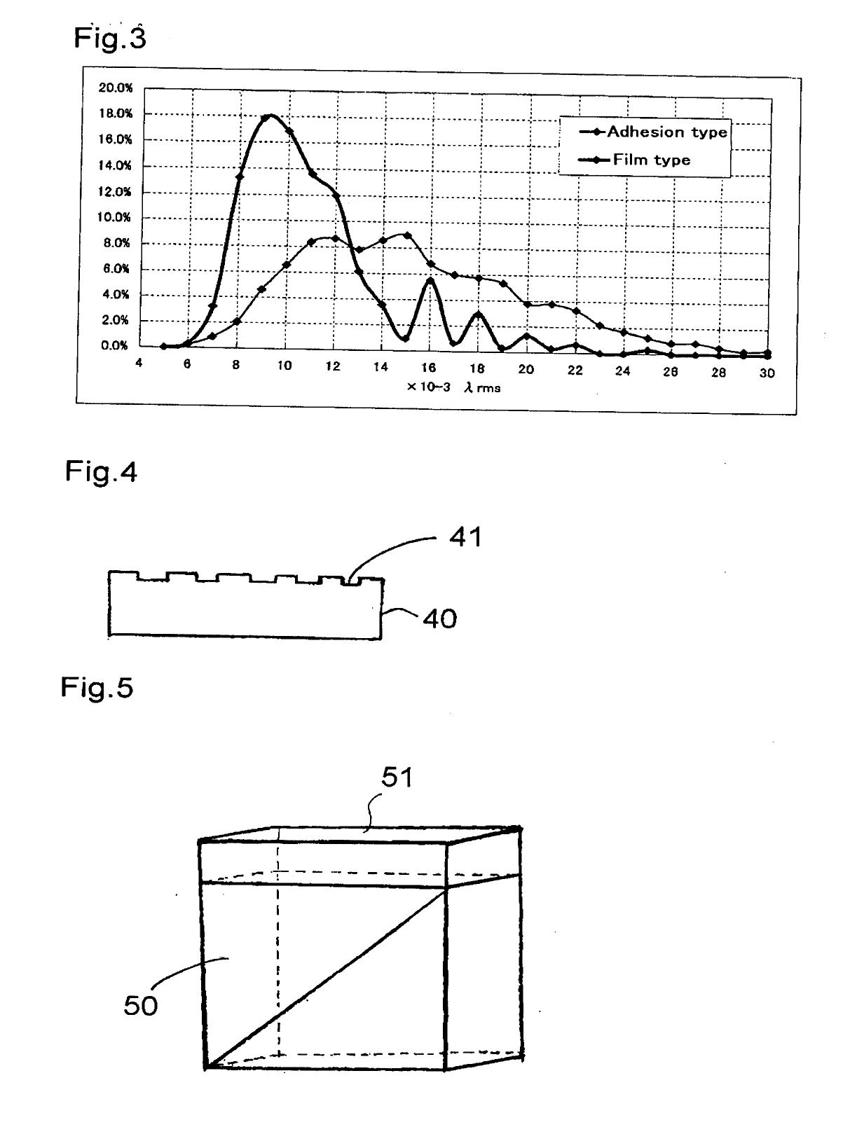

As an example, FIG. 3 shows this point in detail.

It is found from FIG. 3 that the film wavelength plate (film type) of the present invention has more satisfactory wave aberration characteristic than the conventional adhesion-type wavelength plate adhered to a glass substrate.

Besides this embodiment, the diffraction grating 41 can be formed on the film wavelength plate 40 as shown in FIG. 4. In this case, the diffraction grating can be formed by hard-coating the film wavelength plate 40 and etching or hyperfine-processing the resulting hard coat layer. It further can be molded using a die. The diffraction grating can be formed not on the hard coat layer but on the film wavelength plate in the same manner.

As shown in FIG. 5, a film wavelength plate 51 can be attached to a prism 50 by fusing or adhesion. In the case of adhesion, only the periphery of the film wavelength plate is adhered to the prism.

1. An optical head device having a casing in which a light source, a diffraction grating, a polarizing beam splitter, and a collimator lens are arranged, wherein the optical head device comprises a film wavelength plate incorporated therein by being directly attached to the casing in a form free from a support substrate.

2. The optical head device according to claim 1, wherein the film wavelength plate consists of one film, and has a thickness of 0.2 to 1.0 mm.

3. The optical head device according to claim 1, wherein the film wavelength plate is formed by fusing polycarbonate films in a structure of three layers or more.

4. The optical head device according to claim 1, wherein only the periphery of the film wavelength plate is adhered to the optical head device.

5. An optical head device having a casing in which a light source, a diffraction grating, a polarizing beam splitter, and a collimator lens are arranged, wherein the optical head device comprises a film wavelength plate incorporated therein by being directly attached to a prism in a form free from a support substrate.

6. The optical head device according to claim 1, wherein the diffraction grating is formed on the film wavelength plate.

7. The optical head device according to claim 5, wherein the diffraction grating is formed on the film wavelength plate.
